(19) United States
(12) Patent Application Publication
(10) Pub. No.: US 2025/0271371 A1
(43) Pub. Date: Aug. 28, 2025

(54) Method and Apparatus for Capturing Iodine Vapor

(71) Applicants: Romelle Prisca Tiasse Yoder, Los Alamos, NM (US); Benjamin Peter Warner, Los Alamos, NM (US)

(72) Inventors: Romelle Prisca Tiasse Yoder, Los Alamos, NM (US); Benjamin Peter Warner, Los Alamos, NM (US)

(73) Assignee: Palladias LLC, Los Alamos, NM (US)

(21) Appl. No.: 19/060,722

(22) Filed: Feb. 23, 2025

Related U.S. Application Data
(60) Provisional application No. 63/558,859, filed on Feb. 28, 2024.

(51) Int. Cl. G01N 23/223

(52) U.S. Cl. CPC G01N 23/223; G01N 2223/076

(57) ABSTRACT

The present invention includes an apparatus for capturing iodine vapor. The apparatus comprises a chamber having an inlet and an outlet; a sorbent inside of the chamber; and an x-ray fluorescence spectrometer, the x-ray fluorescence spectrometer comprising an x-ray excitation source and an x-ray detector. The present invention also includes an apparatus for capturing iodine vapor, comprising a chamber having an inlet and an outlet; a sorbent disposed inside of the chamber, the sorbent comprising a chemical comprising a plurality of ether functional groups complexed to iodine; and an x-ray fluorescence spectrometer disposed to measure the iodine. The present invention further includes a method for capturing iodine vapor, comprising providing iodine-129, providing a chamber having an inlet and an outlet and a sorbent disposed in the chamber; providing an x-ray fluorescence spectrometer; and obtaining a plurality of x-ray fluorescence measurements of iodine over a period of time.

### CROSS-REFERENCE TO RELATED APPLICATIONS

The present application claims the benefit of Provisional Application No. 63/558,859 filed Feb. 28, 2024.

### FEDERALLY SPONSORED RESEARCH AND DEVELOPMENT

This invention was made with government support under DE-SC0024127 awarded by the Department of Energy. The government has certain rights in the invention.

### PRIOR ART

Kaneniwa, Nobuyoshi, Akiko Ikekawa, and Husako Hayase. “Influence of molecular weight of polyethylene glycol on interaction between polyethylene glycol and iodine.” Chemical and Pharmaceutical Bulletin 22, no. 11 (1974): 2635-2641.
Belyakova, O. A., and A. B. Shipovskaya. “Sorption of iodine-containing vapor onto chitosan.” Russian Journal of Applied Chemistry 89, no. 10 (2016): 1632-1641.

### BACKGROUND OF THE INVENTION

Nuclear power generates approximately 10% of global electricity. Nuclear fuel reprocessing can produce gas phase radioactive iodine, including iodine-129. There are several technologies that are used to capture radioiodine, but these technologies have limitations. For example, many current technologies contain hazardous chemicals such as silver which can make disposal of the captured radioactive iodine difficult because it is considered to be mixed waste, which is a mixture of chemically hazardous waste and radioactive waste, and costs can be enormous (Hanford Cleanup: Alternative Approaches Could Save Tens of Billions of Dollars, GAO-23-106880, Sep. 28, 2023). Requirements for radioiodine capture have been published, such as Riley et al. “Materials and processes for the effective capture and immobilization of radioiodine: A review.” Journal of Nuclear Materials 470 (2016): 307-326 and Riley, Brian J., and Krista Carlson. “Radioiodine sorbent selection criteria.” Frontiers in Chemistry (2022): 1015. Therefore, there remains a need for improved materials, methods, and apparatuses for the capture of vapor phase radioactive iodine.

Poly(ethylene glycols) are known to absorb iodine (Kaneniwa, Nobuyoshi, Akiko Ikekawa, and Husako Hayase. “Influence of molecular weight of polyethylene glycol on interaction between polyethylene glycol and iodine.” Chemical and Pharmaceutical Bulletin 22, no. 11 (1974): 2635-2641). Other chemicals that comprise ether functional groups such as chitosan have also been tested for iodine absorption (Belyakova, O. A., and A. B. Shipovskaya. “Sorption of iodine-containing vapor onto chitosan.” Russian Journal of Applied Chemistry 89, no. 10 (2016): 1632-1641.).

There further remains a need for improved methods and apparatuses to capture vapor phase iodine and to determine the amount of the sorption capacity or lifetime of a sorbent used to capture this iodine.

### SUMMARY OF THE INVENTION

The present invention includes an apparatus for capturing iodine vapor. The apparatus comprises chamber having an inlet and an outlet; a sorbent disposed inside of said chamber; and an x-ray fluorescence (XRF) spectrometer disposed to measure the sorbent, said x-ray fluorescence spectrometer comprising an x-ray excitation source and an x-ray detector.

The present invention also includes an apparatus for capturing iodine vapor, comprising a chamber having an inlet and an outlet; a sorbent disposed inside of said chamber, said sorbent comprising a chemical comprising a plurality of ether functional groups complexed to iodine; and an x-ray fluorescence spectrometer disposed to measure the iodine.

The present invention further includes a method for capturing iodine vapor, comprising providing a source of iodine-129; providing a chamber having an inlet and an outlet and a sorbent disposed in the chamber, where the inlet is disposed to allow iodine-129 to travel from the iodine-129 source to the sorbent; providing an x-ray fluorescence spectrometer; and obtaining a plurality of x-ray fluorescence measurements of iodine over a period of time.

### BRIEF DESCRIPTION OF DRAWINGS

FIG. 1 shows a schematic depiction of the method of the present invention.

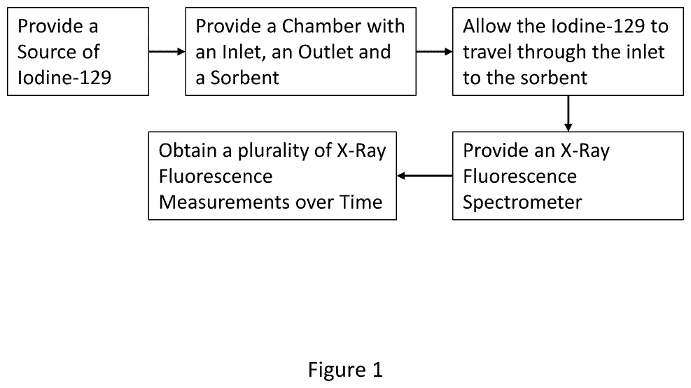

FIG. 2 shows a schematic depiction of an apparatus of the present invention.

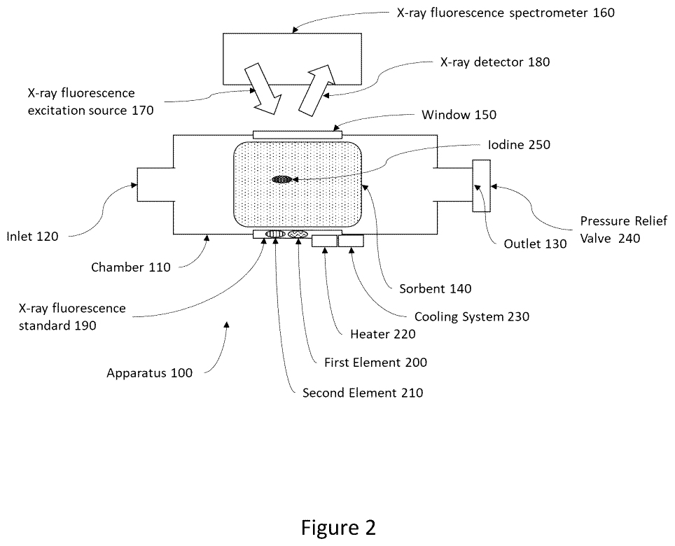

FIG. 3 shows data corresponding to Example 1.

FIG. 4 shows data corresponding to Example 2.

### DETAILED DESCRIPTION OF THE INVENTION

Briefly, the present invention includes an apparatus for capturing iodine vapor. Apparatus 100 comprises a chamber 110 having an inlet 120 and an outlet 130; a sorbent 140 disposed inside of said chamber 110; and an x-ray fluorescence spectrometer 160 disposed to measure the sorbent 140, said x-ray fluorescence spectrometer 160 comprising an x-ray excitation source 170 and an x-ray detector 180.

Apparatus 100 preferably further comprises an x-ray fluorescence standard 190. The x-ray fluorescence standard 190 is positioned so that at least a portion of the sorbent 140 is between the x-ray fluorescence standard 190 and the x-ray fluorescence excitation source 170, and also so that the standard 190 is excited by the x-ray fluorescence excitation source 170 and x-rays that are emitted by the x-ray fluorescence standard 190 are detected by the x-ray detector 180. This positioning allows the sorbent 140, any iodine 250 that is captured by the sorbent, and the x-ray fluorescence standard 190 to be measured simultaneously. This simultaneous measurement allows the iodine in the sorbent to be quantified, and repeated measurements over time allow the rate of iodine uptake by the sorbent to be quantified.

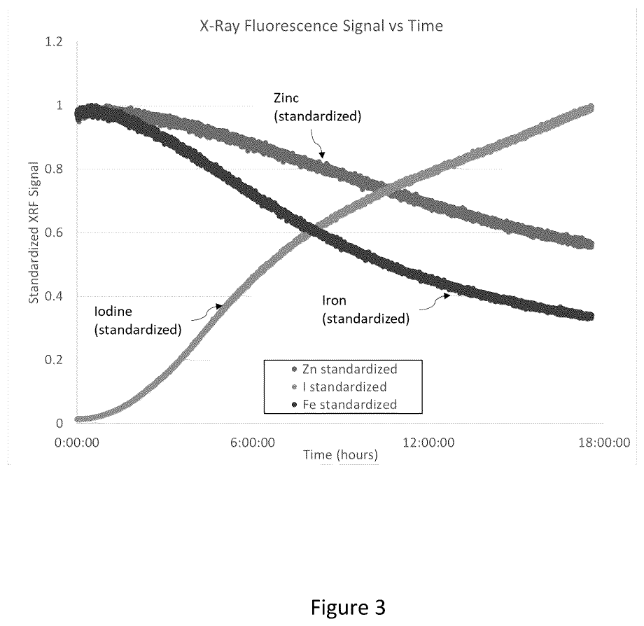

The x-ray fluorescence standard 190 preferably comprises two different elements (where the first element is denoted as First Element 200 and the second element is denoted as Second Element 210), where each element has a characteristic x-ray fluorescence emission signal that is different from a characteristic x-ray fluorescence signal from the other element. Preferably, each of the elements has a characteristic x-ray fluorescence signal that has an energy that is between 3 keV and 10 keV. The presence of at least two x-ray fluorescence signals allows convenient quantification of iodine across a range of concentrations. For example, as shown in FIG. 3, the iron x-ray fluorescence signal at 6.4 keV provides a more sensitive indicator for lower iodine concentrations, while the zinc x-ray fluorescence signal at 8.6 keV provides a more sensitive indicator at higher iodine concentrations. These elemental standards may be conveniently provided by a metal alloy, such as an aluminum alloy. The aluminum alloy preferably comprises two metals, where the metal is selected from the set consisting of titanium, vanadium, chromium, manganese, iron, cobalt, nickel, copper, and zinc.

The sorbent 140 preferably sorbs iodine, and more preferably sorbs molecular di-iodine from the vapor phase. The mechanism of iodine binding can be conveniently determined using UV-Vis spectrometry, as described in Kaneniwa, Nobuyoshi, Akiko Ikekawa, and Husako Hayase. “Influence of molecular weight of polyethylene glycol on interaction between polyethylene glycol and iodine.” Chemical and Pharmaceutical Bulletin 22, no. 11 (1974): 2635-2641. Sorbents that bind iodine are conveniently provided by the use of sorbents that comprise ether functional groups, and more preferably by polymers that comprise a plurality of ether functional groups. The material properties of the sorbent may be tuned by supporting the polymer on a solid support, such as by adsorbing the polymer on a solid support or by covalently attaching the polymer to a solid support. Examples of polymers comprising a plurality of ether functional groups that may be used in the present invention include poly (ethylene glycol), polysaccharides, polycarbophil, cellulose, chitin, and chitosan, as well as chemical derivatives of those polymers that comprise additional ether functional groups such as methyl cellulose.

The chamber preferably comprises a window 150 that is translucent to x-rays having an energy of 3.9 keV, and more preferably the window 150 allows at least 5% of the x-rays having an energy of 3.9 keV that are incident normal to the inner side of the window to pass through the window. The translucency of windows may be calculated based on the following publication: B. L. Henke, E. M. Gullikson, and J. C. Davis. X-ray interactions: photoabsorption, scattering, transmission, and reflection at E=50-30000 eV, Z=1-92, Atomic Data and Nuclear Data Tables Vol. 54 (no. 2), 181-342 (July 1993). A convenient calculator tool is available at

https://henke.lbl.gov/optical_constants/atten2.html and
https://henke.lbl.gov/optical_constants/. Examples of windows that may be used with polypropylene, and 360 micron thick mylar.

The apparatus also optionally comprises a heating system 220 to maintain the minimum temperature of the sorbent. Preferably the heater 220 maintains the sorbent at a temperature of 5 degrees Celsius or above. The apparatus also optionally comprises a cooling system 230 to maintain the maximum temperature of the sorbent. Preferably the cooling system 230 maintains the sorbent at or below a maximum temperature of 160 degrees Celsius.

X-Ray excitation source 170 is preferably capable of efficiently exciting the elements iodine and at least two of the elements titanium, vanadium, chromium, manganese, iron, cobalt, nickel, copper, and zinc. Examples of suitable x-ray excitation sources 170 include x-ray tubes, such as a 50 W (50 kV and 1 mA) x-ray tube with an anode comprising tungsten, molybdenum, rhodium, or chromium. The x-ray excitation source is more preferably a microfocus x-ray tube, which provides a higher flux of x-rays. The x-ray excitation source optionally comprises a focusing optic, such as a polycapillary focusing optic.

X-ray detector 180 is preferably capable of distinguishing iodine XRF signals, as well as iodine-129 gamma radiation having an energy of 29.8 keV and/or 39.6 keV, as well as the XRF signals from at least two of the elements selected from the list of titanium, vanadium, chromium, manganese, iron, cobalt, nickel, copper, and zinc. Examples of x-ray detector 180 include solid state PIN detectors, silicon solid state detectors, and proportional counters. X-ray detector 180 preferably does not require cooling with liquid nitrogen.

X-Ray excitation source 170 is preferably capable of efficiently exciting the elements iodine and at least two of the elements titanium, vanadium, chromium, manganese, iron, cobalt, nickel, copper, and zinc. Examples of suitable x-ray excitation sources 170 include x-ray tubes, such as a 50 W (50 kV and 1 mA) x-ray tube with an anode comprising tungsten, molybdenum, rhodium, or chromium. The x-ray excitation source is more preferably a microfocus x-ray tube, which provides a higher flux of x-rays. The x-ray excitation source optionally comprises a focusing optic, such as a polycapillary focusing optic.

The apparatus further optionally comprises a pressure relief valve 240. Pressure relief valve 240 is optionally disposed at or near outlet 130 of the apparatus.

The x-ray fluorescence detector 180 is also preferably capable of measuring photons having an energy of 29.8 keV and/or 39.6 keV (Barescut, J. C., J. C. Gariel, J. M. Peres, E. Barker, M. Masson, P. Bouisset, N. Cariou, P. Germain, and F. Siclet. “129| determination by direct gamma-X spectrometry and its application to concentration variations in two seaweed species.” Radioprotection 40, no. S1 (2005): S581-S587.). The combination of the measurement of these photons which are emitted by iodine-129 and the x-ray fluorescence signal of the iodine in the sorbent 140 allows the quantification of both iodine-129 and non-radioactive iodine; this information may be used to determine the radioactivity level of the iodine in sorbent 140 or in apparatus 100 and what method of disposal is appropriate.

The present invention also includes an apparatus for capturing iodine vapor. An apparatus for capturing iodine vapor, comprising a chamber having an inlet and an outlet; a sorbent disposed inside of said chamber, said sorbent comprising a chemical comprising a plurality of ether functional groups complexed to iodine; and an x-ray fluorescence spectrometer disposed to measure the iodine. In this embodiment of the present invention, the iodine that is initially present in sorbent is used to allow the performance of the x-ray fluorescence components of the instrument to be determined and calibrated prior to the introduction of radioactive iodine 129 to the filter. In this way, a defective filter or filter monitoring system can be repaired or replaced prior to the formation of radioactive waste in the filter.

The present invention further comprises a method for capturing iodine vapor. The method includes the steps of providing a source of iodine-129; providing a chamber having an inlet and an outlet and a sorbent disposed in the chamber, the inlet disposed to allow iodine-129 to travel from the iodine-129 source to the sorbent; providing an x-ray fluorescence spectrometer; and obtaining a plurality of x-ray fluorescence measurements of iodine over a period of time. As shown in the examples, the use of a plurality of x-ray fluorescence measurements allows the kinetic performance of the filter to be determined, and allows determination of how saturated the filter is; this information can be used to determine when the filter should be replaced. The x-ray fluorescence spectrometer comprises an x-ray excitation source and an x-ray detector.

The method preferably further comprises providing an x-ray fluorescence standard, positioned so that at least a portion of the sorbent is between the x-ray fluorescence standard and the x-ray fluorescence excitation source, and also so that the standard is excited by the x-ray fluorescence excitation source and x-rays that are emitted by the x-ray fluorescence standard are detected by the x-ray detector. This positioning allows the sorbent, any iodine that is captured by the sorbent, and the x-ray fluorescence standard to be measured simultaneously. This simultaneous measurement allows the iodine in the sorbent to be quantified, and repeated measurements over time allow the rate of iodine uptake by the sorbent to be quantified.

The x-ray fluorescence standard preferably comprises two different elements, where each element has a characteristic x-ray fluorescence emission signal that is different from a characteristic x-ray fluorescence signal from the other element. Preferably, each of the elements has a characteristic x-ray fluorescence signal that has an energy that is between 3 keV and 10 keV. The presence of at least two x-ray fluorescence signals allows convenient quantification of iodine across a range of concentrations. For example, as shown in FIG. 3, the iron x-ray fluorescence signal at 6.4 keV provides a more sensitive indicator for lower iodine concentrations, while the zinc x-ray fluorescence signal at 8.6 keV provides a more sensitive indicator at higher iodine concentrations. These elemental standards may be conveniently provided by a metal alloy, such as an aluminum alloy. The aluminum alloy preferably comprises two metals, where the metal is selected from the set consisting of titanium, vanadium, chromium, manganese, iron, cobalt, nickel, copper, and zinc.

The sorbent preferably sorbs iodine, and more preferably sorbs molecular di-iodine from the vapor phase. The mechanism of iodine binding can be conveniently determined using UV-Vis spectrometry, as described in Kaneniwa, Nobuyoshi, Akiko Ikekawa, and Husako Hayase. “Influence of molecular weight of polyethylene glycol on interaction between polyethylene glycol and iodine.” Chemical and Pharmaceutical Bulletin 22, no. 11 (1974): 2635-2641. Sorbents that bind iodine are conveniently provided by the use of sorbents that comprise ether functional groups, and more preferably by polymers that comprise a plurality of ether functional groups. The material properties of the sorbent may be tuned by supporting the polymer on a solid support, such as by adsorbing the polymer on a solid support or by covalently attaching the polymer to a solid support. Examples of polymers comprising a plurality of ether functional groups that may be used in the present invention include poly (ethylene glycol), polysaccharides, polycarbophil, cellulose, chitin, and chitosan, as well as chemical derivatives of those polymers that comprise additional ether functional groups such as methyl cellulose.

The chamber preferably comprises a window that is translucent to x-rays having an energy of 3.9 keV, and more preferably the window allows at least 5% of the x-rays having an energy of 3.9 keV that are incident normal to the inner side of the window to pass through the window. The translucency of windows may be calculated based on the following publication: B. L. Henke, E. M. Gullikson, and J. C. Davis. X-ray interactions: photoabsorption, scattering, transmission, and reflection at E=50-30000 eV, Z=1-92, Atomic Data and Nuclear Data Tables Vol. 54 (no. 2), 181-342 (July 1993). A convenient calculator tool is available at https://henke.lbl.gov/optical_constants/atten2.html and https://henke.lbl.gov/optical_constants/. Examples of windows that may be used with polypropylene, and 360 micron thick mylar.

The method also optionally comprises providing a heating system to maintain the minimum temperature of the sorbent. Preferably the heater maintains the sorbent at a temperature of 5 degrees Celsius or above. The method also optionally comprises providing a cooling system to maintain the maximum temperature of the sorbent. Preferably the cooling system maintains the sorbent at or below a maximum temperature of 160 degrees Celsius.

The method further optionally comprises providing a pressure relief valve. The pressure relief valve is optionally disposed at or near the outlet of the chamber.

The x-ray fluorescence detector is also preferably capable of measuring photons having an energy of 29.8 keV and/or 39.6 keV (Barescut, J. C., J. C. Gariel, J. M. Peres, E. Barker, M. Masson, P. Bouisset, N. Cariou, P. Germain, and F. Siclet. “1291 determination by direct gamma-X spectrometry and its application to concentration variations in two seaweed species.” Radioprotection 40, no. S1 (2005): S581-S587.). The combination of the measurement of these photons which are emitted by lodine-129 and the x-ray fluorescence signal of the iodine in the filter allows the quantification of both lodine-129 and non-radioactive lodine; this information may be used to determine the radioactivity level of the sorbent and what method of disposal is appropriate.

### EXAMPLES

Example 1: A chamber with an inlet and an outlet was constructed using 3 mm thick acrylic, with a window comprised of Scotch® Magic™ Tape, 810-212-C, and a back wall comprising 6061 aluminum. A sorbent comprising methyl cellulose (CAS number 9004-67-5) was placed in the chamber. lodine vapor was allowed to diffuse into the chamber, while x-ray fluorescence measurements were obtained. The x-ray fluorescence signals for iodine, iron, and zinc are shown in FIG. 3, where the intensity of the iron, zinc, and iodine signals are shown standardized to their maximum intensities observed during the experiment. The change in intensity of the iodine signal shows different slopes in the period from 2.5 hours to 5.5 hours and the period from 9.5 hours to 17.5 hours. During the period from 2.5-5.5 hours the correlation of the iron signal to the iodine signal is higher than the correlation of the zinc signal to the iodine signal. During the period from 9.5-17.5 hours the correlation of the zinc signal to the iodine signal is higher than the correlation of the iron signal to the iodine signal.

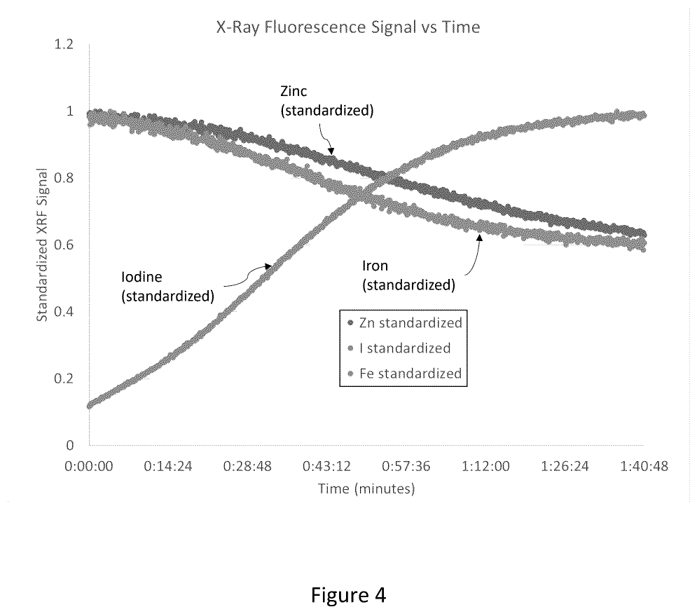

Example 2: A chamber with an inlet and an outlet was constructed using 3 mm thick acrylic, with a window comprised of Scotch® Magic™ Tape, 810-212-C, and a back wall comprising 6061 aluminum. A sorbent comprising polyethylene glycol 3350 (CAS number 25322-68-3) was placed in the chamber. lodine vapor was allowed to diffuse into the chamber, while x-ray fluorescence measurements were obtained. The x-ray fluorescence signals for iodine, iron, and zinc are shown in FIG. 4, where the intensity of the iron, zinc, and iodine signals are shown standardized to their maximum intensities observed during the experiment. The change in intensity of the iodine signal shows different slopes in the period from 15 minutes to 40 minutes and the period from 110 minutes to 140 minutes. During the period from 15 minutes to 40 minutes the correlation of the iron signal to the iodine signal is higher than the correlation of the zinc signal to the iodine signal. During the period 110 minutes to 140 minutes hours the correlation of the zinc signal to the iodine signal is higher than the correlation of the iron signal to the iodine signal.

The foregoing description of the invention has been presented for purposes of illustration and description and is not intended to be exhaustive or to limit the invention to the precise form disclosed, and obviously many modifications and variations are possible in light of the above teaching.

The embodiment(s) were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for capturing iodine vapor, comprising:
a. a chamber having an inlet and an outlet;
b. a sorbent disposed inside of said chamber; and
c. an x-ray fluorescence spectrometer disposed to measure the sorbent, said x-ray fluorescence spectrometer comprising an x-ray excitation source and an x-ray detector.

2. The apparatus of claim 1, further comprising an x-ray fluorescence standard, positioned so that the sorbent is between the x-ray fluorescence standard and the x-ray fluorescence excitation source.

3. The apparatus of claim 2, wherein the x-ray fluorescence standard comprises at least two chemical elements each having an x-ray fluorescence signal between 3 keV and 10 keV.

4. The apparatus of claim 3, wherein the x-ray fluorescence standard is an alloy comprising two metals each having an x-ray fluorescence signal between 3 keV and 10 keV.

5. The apparatus of claim 4, wherein each of the two metals is selected from the set consisting of titanium, vanadium, chromium, manganese, iron, cobalt, nickel, copper, and zinc.

6. The apparatus of claim 5, wherein the alloy is an alloy of aluminum.

7. The apparatus of claim 1, wherein the sorbent comprises an ether functional group.

8. The apparatus of claim 7, wherein the sorbent comprises a polymer, where the polymer comprises a plurality of ether functional groups.

9. The apparatus of claim 7, wherein the polymer is supported by a solid support.

10. The apparatus of claim 8, wherein the polymer is covalently bonded to a solid support.

11. The apparatus of claim 7, wherein the sorbent comprises a chemical selected from poly (ethylene glycol), polysaccharides, cellulose, polycarbophil, chitin, chitosan, and derivatives thereof that comprise additional ether functional groups.

12. The apparatus of claim 1, wherein at least one portion of the chamber is translucent to x-rays having energies of 3.9 keV.

13. The apparatus of claim 12, wherein at least one portion of the chamber allows the transmission of at least 5% of x-rays having an energy of 3.9 keV.

14. The apparatus of claim 1, further comprising a temperature control system to keep the sorbent maintained at a temperature above 5 degrees Celsius.

15. The apparatus of claim 1, further comprising a temperature control system to keep the sorbent maintained at a temperature below 160 degrees Celsius.

16. The apparatus of claim 1, further comprising a temperature control system to keep the sorbent maintained at a temperature of between 5 degrees Celsius and 160 degrees Celsius.

17. An apparatus for capturing iodine vapor, comprising a chamber having an inlet and an outlet; a sorbent disposed inside of said chamber, said sorbent comprising a chemical comprising a plurality of ether functional groups complexed to iodine; and an x-ray fluorescence spectrometer disposed to measure the iodine.

18. A method for capturing iodine vapor, comprising providing a source of lodine-129;
providing a chamber having an inlet and an outlet and a sorbent disposed in the chamber, the inlet disposed to allow lodine-129 to travel from the lodine-129 source to the sorbent; providing an x-ray fluorescence spectrometer; and obtaining a plurality of x-ray fluorescence measurements of iodine over a period of time.

19. The method of claim 18, further comprising obtaining x-ray fluorescence measurements of at least two other elements having x-ray fluorescence signals between 3 keV and 10 keV at simultaneous with the measurements of iodine.
